(19) United States
(12) Patent Application Publication
(10) Pub. No.: US 2008/0243974 A1
(43) Pub. Date: Oct. 2, 2008

(54) ELECTRONIC DATA SHIFT DEVICE, IN PARTICULAR FOR CODING/DECODING WITH AN LDPC CODE

(75) Inventors: Laurent Paumier, Grenoble (FR); Vincent Heinrich, La Tronche (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 12/046,829

(22) Filed: Mar. 12, 2008

(30) Foreign Application Priority Data
Mar. 28, 2007 (FR) 0754102

(51) Int. Cl. G06F 5/01

(52) U.S. Cl. 708/209

(57) ABSTRACT

The electronic shift device includes N inputs and N outputs, a configurable barrel shifter connected between the N inputs and the N outputs. A second shifter is arranged and connected between some of the outputs of the barrel shifter and some of the N outputs according to different predetermined organizations of data that can be received simultaneously on at least some of the N inputs. The second shifter is configurable so that, for a relevant organization and regardless of the desired shift value compatible with the organization, the corresponding input data are delivered to predetermined outputs. A first controller is able to configure the barrel shifter according to the desired shift value and a second controller is able to configure the second shifter according to the organization of the data that can actually be received and according to the desired shift value.

### FIELD OF THE INVENTION

The invention relates to data shift devices which may be used to perform a cyclical permutation of the input data. Such devices are, for example, but not exclusively, used in channel coding devices including encoders using codes based on blocks with a parity matrix that has a low density and are more widely known to those skilled in the art as an “LDPC code” (“Low Density Parity Check”), or in channel decoding devices including LDPC decoders, or in devices using turbocodes to perform a part of the data interleaving.

### BACKGROUND OF THE INVENTION

LDPC codes are proposed for numerous standards (e.g. 802.11n, 802.16e, DVB-S2, etc.). The emergence of these numerous standards requires these data shift devices to be flexible and reconfigurable in hardware terms. Conventional data shift devices are commonly known to those skilled in the art as barrel shifters. These barrel shifters are based on a logarithmic architecture of multiplexers and, when they are of size N (that is, having N inputs and N outputs), they offer a simple approach for performing a cyclical shift of N data delivered as input to the circuit via a bus of size N. Conversely, when only a part of the data bus is used, that is, when the barrel shifter is fed with a number of data less than N, the outputs of the barrel shifter, to which the shifted data are delivered, vary according to the desired shift value. In other words, the “output wires” actually used, that is, conveying the shifted output data, are not the same, for a given bus size, according to the shift value. This may pose a problem when there is a need to connect another circuit downstream of the barrel shifter.

Also, it can immediately be seen that these barrel shifters may not offer a satisfactory approach to the hardware flexibility and reconfigurability mentioned above and required to satisfy the emergence of different standards, except, of course, by using as many barrel shifters as there are bus sizes to be envisaged, involving an appropriate selection device, or even a single barrel shifter having the maximum size with, downstream, a complex wire routing device configurable according to the actual size of the input data bus. Now, these two approaches may cover a relatively large surface area and/or may pose complex routing problems.

### SUMMARY OF THE INVENTION

According to one embodiment, a shift device is proposed that offers a certain flexibility as to the number of input data that can be received and with a surface area that is smaller than an approach providing for the use of several barrel shifters of different sizes. According to one aspect, an electronic shift device is proposed, comprising a configurable barrel shifter connected between the inputs and the outputs of the device and a first controller or means to configure the barrel shifter according to the desired shift value.

According to a general characteristic of this aspect, the device also comprises a second shifter, arranged and connected to the barrel shifter according to different predetermined organizations of data that can be received simultaneously on at least some of the inputs of the device and configurable so that, for a relevant organization and regardless of the desired shift value compatible with the organization, the corresponding input data are delivered to predetermined outputs of the device. An input data organization is, for example, in particular representative of the number of input data, that is, the actual size of the input bus, but also of the way in which the input data that are simultaneously received on the N inputs are arranged. Thus, these data can, for example, be organized in a single group or even in several groups.

The device also comprises a second controller or means to configure the second shifter according to the organization of the data that can actually be received as input and according to the desired shift value. In other words, according to this aspect, a second shifter is connected downstream or upstream of a conventional barrel shifter, and complements the latter to form a single multimode shift device, that is, one that is capable of supporting several real bus sizes by delivering the output data on predetermined wires, regardless of the desired shift value.

Also, whereas the first controller of the barrel shifter configures this barrel shifter conventionally according only to the desired shift value but independently of the organization of the data present at the input (number of data, organization into a single group, into several groups, and so on), the second controller is able to configure the second shifter not only according to the desired shift value, but also according to the organization of the data that can actually be received.

According to a variant, in which the device comprises N inputs and N outputs and the data that can be received simultaneously as input to the device are organized in a single group, the size of which is chosen from the size N and at least one predetermined intermediate size that is different from N and greater than 1, the second shifter is arranged and connected according to the predetermined intermediate size or sizes, and the second controller is able to configure the second shifter according to the chosen size of the group of data that can actually be received and according to the desired shift value.

According to one embodiment, valid regardless of the downstream or upstream placement of the second shifter, the second shifter comprises a number of shift stages equal to the number of predetermined intermediate sizes, each shift stage being associated with a predetermined intermediate size.

According to an embodiment corresponding to a connection of the second shifter downstream of the barrel shifter, the second shifter is connected between some of the outputs of the barrel shifter and some of the outputs of the device according to the different predetermined organizations of data that can be received simultaneously on at least some of the inputs.

According to an embodiment compatible with a downstream connection, each shift stage has a first state in which it is configured to perform a shift of at least one datum and a second state in which it is configured to shift no data, and the second controller is able to configure in its first state the shift stage associated with the intermediate size of the group of data that can actually be received and configure any other shift stages in their second state, or configure each shift stage in its second state if the size of the group of data that can actually be received is equal to 1 or to N.

According to another possible embodiment, each shift stage has a first state in which it is configured to perform a shift of at least one datum, a second state in which it is configured to shift no data and/or a third state in which it is configured to perform no shift of at least some of the data, and the second controller is able to configure in its first state the shift stage associated with the intermediate size of the group of data that can actually be received, configure in its second state or its third state any other shift stages, or configure each shift stage in its second state if the size of the group of data that can actually be received is equal to 1 or to N.

For example, the shift stage associated with a predetermined intermediate size value p comprises p−1 multiplexing block or means that can be controlled individually, each multiplexing means having an output connected to one of the N outputs of the device, a first input connected to the output of the barrel shifter having the same rank as the output of the device and a second input connected to another output of the barrel shifter. Each multiplexing means has a first state in which its output is connected to its second input and a second state in which its output is connected to its first input, and at least one multiplexing means is in its first state when the shift stage is in its first state whereas all the multiplexing means of the stage are in their second state when the shift stage is in its second state. Where appropriate, at least some of the multiplexing means can be in their second state when the shift stage is in its third state.

According to an embodiment corresponding to a connection of the second shifter upstream of the barrel shifter, the second shifter is connected between some of the inputs of the device and some of the inputs of the barrel shifter according to the different predetermined organizations of data that can be received simultaneously on at least some of the inputs.

According to an embodiment compatible with an upstream connection, each shift stage has a first state in which it is configured to perform a shift of at least one datum, a second state in which it is configured to shift no data and/or a third state in which it is configured to perform no shift of at least some of the data. In fact, in this third state, any other data can be shifted or not because this is unimportant since these data will, given the control of the barrel shifter, be switched to outputs of the device other than the predetermined outputs. Moreover, the second controller is able to configure in its first state the shift stage associated with the intermediate size of the group of data that can actually be received, configure in its second state each shift stage disposed between the inputs of the device and the shift stage associated with the intermediate size of the group of data that can actually be received as input to the device, configure in its second or its third state each shift stage disposed between the shift stage associated with the intermediate size of the group of data that can actually be received as input to the device and the barrel shifter, or configure each shift stage in its second state if the size of the group of data that can actually be received is equal to 1 or to N.

For example, the shift stage associated with a predetermined intermediate size value p comprises p−1 multiplexing means that can be controlled separately, each multiplexing means having a first input connected to an input of the device, an output connected to the input of the barrel shifter having the same rank as the input of the device and a second input connected to another input of the device. Each multiplexing means has a first state in which its output is connected to its second input and a second state in which its output is connected to its first input, and at least one multiplexing means is in its first state when the shift stage is in its first state, all the multiplexing means of the stage are in their second state when the shift stage is in its second state and at least some of the multiplexing means are in their second state when the shift stage is in its third state. Whatever the placement of the second shifter relative to the barrel shifter, the second control means are advantageously able to control separately each multiplexing means of a shift stage according to the desired shift value.

If the input data are coded on a single bit, each multiplexing block or means is in fact a multiplexer. Conversely, if the input data are coded on several bits, each multiplexing means is a set of several multiplexers connected in parallel and respectively associated with the data bits. Each set of multiplexers can be controlled separately and all the multiplexers of one and the same set may be controlled identically.

According to another variant of the invention in which the device comprises N inputs and N outputs and the data that can be received simultaneously as input to the device are organized in a single group of size N or in several groups each having an identical intermediate size chosen from at least one of the predetermined intermediate sizes different to N and greater than 1, the second shifter is arranged and connected according to the predetermined intermediate size or sizes and the number g of groups, and the second controller is able to configure the second shifter according to the chosen size of the group or groups of data that can actually be received and according to the same desired shift value in the case of several groups.

According to one embodiment, the second shifter has a number of shift stages equal to the number of predetermined intermediate sizes, each shift stage being associated with a predetermined intermediate size.

According to an embodiment compatible with a connection of the second shifter downstream of the barrel shifter, each shift stage has a first state in which it is configured to perform a shift of at least one datum per group and a second state in which it is configured to shift no data, and the second controller is able to configure in its first state the shift stage associated with the intermediate size of each group of data that can actually be received, and configure any other shift stages in their second state, or configure each shift stage in its second state if the data simultaneously received form a single group of size N.

According to another possible embodiment, each shift stage has a first state in which it is configured to perform a shift of at least one datum per group, a second state in which it is configured to shift no data and/or a third state in which it is configured to perform no shift of at least some of the data of each group. The second controller is able to configure in its first state the shift stage associated with the intermediate size of the group of data that can actually be received, configure in its second or its third state the other shift stages, or configure each shift stage in its second state if the size of the group of data that can actually be received is equal to 1 or to N.

For example, the shift stage associated with a predetermined intermediate size value p comprises g groups of p−1 multiplexing means that can be controlled separately, each multiplexing means having an output connected to one of the N outputs of the device, a first input connected to the output of the barrel shifter having the same rank as the output of the device and a second input connected to another output of the barrel shifter. Each multiplexing means has a first state in which its output is connected to its second input and a second state in which its output is connected to its first input, and at least one multiplexing means is in its first state when the shift stage is in its first state whereas all the multiplexing means of the stage are in their second state when the shift stage is in its second state. Where appropriate, at least some of the multiplexing means are in their second state when the shift stage is in its third state.

According to an embodiment compatible with a connection of the second shifter upstream of the barrel shifter, each shift stage has a first state in which it is configured to perform a shift of at least one datum per group, a second state in which it is configured to shift no data and/or a third state in which it is configured to perform no shift of at least some of the data of each group. The second controller is able to configure in its first state the shift stage associated with the intermediate size of the group of data that can actually be received, configure in its second state each shift stage disposed between the inputs of the device and the shift stage associated with the intermediate size of the group of data that can actually be received as input to the device, configure in its second or its third state each shift stage disposed between the shift stage associated with the intermediate size of the group of data that can actually be received as input to the device and the barrel shifter, or configure each shift stage in its second state if the size of the group of data that can actually be received is equal to 1 or to N.

For example, the shift stage associated with a predetermined intermediate size value p comprises g groups of p−1 multiplexing means that can be controlled separately, each multiplexing means having a first input connected to an input of the device, an output connected to the input of the barrel shifter having the same rank as the input of the device and a second input connected to another input of the device. Each multiplexing means has a first state in which its output is connected to its second input and a second state in which its output is connected to its first input, and at least one multiplexing means is in its first state when the shift stage is in its first state, all the multiplexing means of the stage are in their second state when the shift stage is in its second state and at least some of the multiplexing means are in their second state when the shift stage is in its third state.

Regardless of the placement of the second shifter relative to the barrel shifter, the second controller is advantageously able to control individually each multiplexing means of a group according to the desired shift value and control identically the peer multiplexers of the g groups. The shift device can, for example, be produced in the form of an integrated circuit.

According to another aspect, a channel coding device is also proposed, in particular able to perform an encoding with an LDPC code, incorporating a shift device as defined above. According to another aspect, a channel decoding device is also proposed, in particular able to perform a decoding of blocks encoded with an LDPC code, incorporating a shift device as defined above.

### BRIEF DESCRIPTION OF THE DRAWINGS

Other advantages and characteristics of the invention will become apparent from studying the detailed description of non-limiting embodiments and the appended drawings in which:

FIG. 1 is a schematic diagram illustrating an embodiment of a data shift device in accordance with the present invention;

FIGS. 2 to 5 are schematic diagrams illustrating an embodiment and an example of operation of a barrel shifter incorporated in the data shift device of FIG. 1;

FIGS. 6 to 28 are schematic diagrams illustrating different embodiments and modes of operation of a data shift device in accordance with the present invention;

FIG. 29 is a schematic diagram illustrating the internal structure of a communication subsystem, for example a wireless apparatus, incorporating channel coding and decoding blocks; and,

FIG. 30 illustrates in more detail but still diagrammatically an embodiment of an LDPC decoder incorporating a data shift device in accordance with the present invention.

### DETAILED DESCRIPTION OF THE PREFERRED EMBODIMENTS

In FIG. 1 the reference DDC denotes an electronic shift device comprising N inputs E1-EN and N outputs S1-SN. The device DDC is able to receive data Wi originating from an input bus BSE, and deliver shifted data on an output bus BSS. As will be seen in more detail below, the organization of these data that can actually be received as input to the device DDC can be different and is chosen from a certain number of predetermined organizations.

Thus, for example, the device DDC can simultaneously receive N data W1-WN organized, for example, in a single group, or even a group of data with a size greater than 1 and less than N and chosen from certain predetermined sizes. The input data can also be organized in several groups received simultaneously as input to the device DDC. In other words, the device DDC is here a multimode device in as much as it is capable of handling the case of a bus BSE of size N, that is, simultaneously receiving N data as input, or even the case of a bus of intermediate size, that is, receiving as input a number of data less than N taken from predetermined numbers or modes. The device is also capable of handling data organized in several groups of data received simultaneously.

And, whatever the organization of the input data, the device DDC will deliver the shifted output data on predetermined outputs of the device DDC, regardless of the envisaged shift value compatible with the organization of the input data. Thus, one example of shift value compatible with an input organization is a shift value less than the size of the group of data received or of the different groups of data received simultaneously.

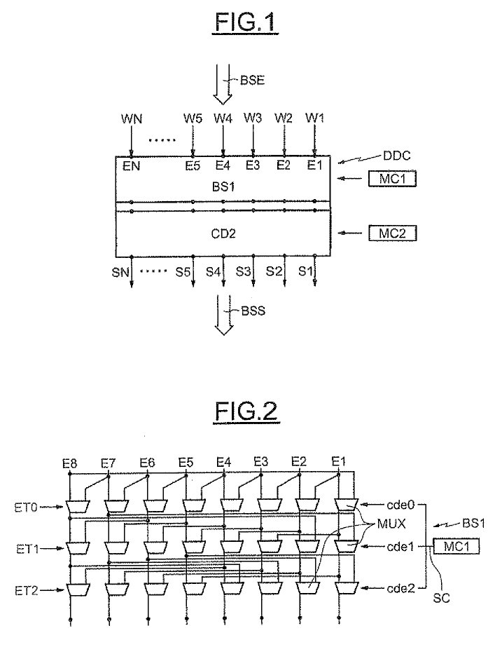

The data shift device DDC here comprises a barrel shifter BS1, of conventional structure and known per se. This barrel shifter BS1 here has a size N, that is, it comprises N inputs and N outputs. It is configurable and configured by a first controller or control means MC1 delivering for each stage of the barrel shifter control signals cdei (FIG. 2). The architecture of a barrel shifter is based on a logarithmic architecture. More specifically, the number of multiplexers of a shifter BS1 of size N is equal to ceil(log 2(N))*N, in which the function “ceil” denotes the upper integer part.

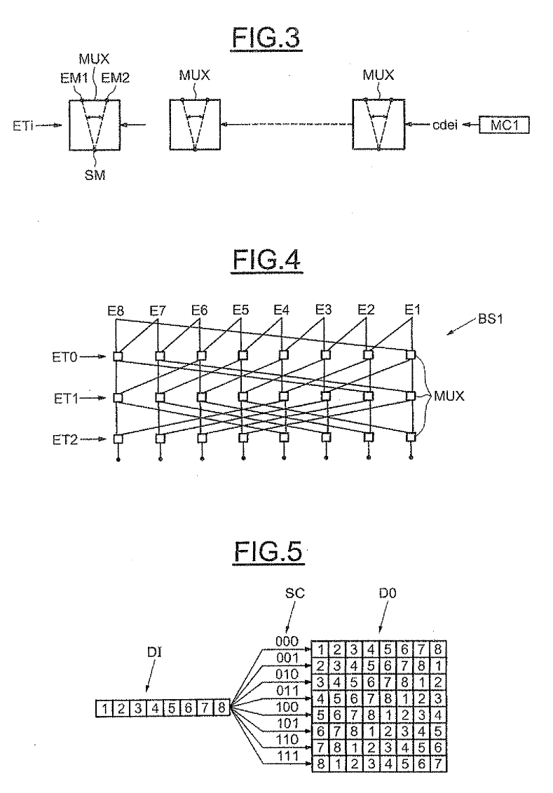

FIG. 2 illustrates in greater detail the internal architecture of a barrel shifter BS1 of size 8 consequently comprising three multiplexing stages ET0, ET1, ET2. As illustrated in FIG. 3, each multiplexer MUX comprises a first input EM1, a second input EM2 and an output SM. The first input EM1 of each multiplexer of the stage ET0 is connected to the input Ei having a rank i equal to the rank of the multiplexer MUX. The second input EM2 is connected to another input.

In practice, as illustrated in FIG. 2, the barrel shifter is in this case a left-shifting circuit, that is, the first stage ET0 can shift by one rank (2nd rank) the data present at the input whereas the next stage ET1 can shift the data by 2¹ ranks. The third stage ET2 can shift the data to the left by 2² ranks. More generally, as is well known to those skilled in the art, the stage of rank r (r starting at 0) can left-shift the data by 2^{r} ranks.

The multiplexers MUX each comprise an output SM which can be linked either to the first input EM1 or to the second input EM2 depending on the value of the corresponding control signal. If the output SM is linked to the first input EM1, the multiplexer does not shift the datum, whereas if the output is linked to the input EM2, the multiplexer shifts the datum. In practice, as is well known in barrel shifters, there is a control signal for each stage of the barrel shifter, this control signal cdei controlling identically all the multiplexers of the stage. In practice, as is illustrated more specifically in FIG. 5, to which we will return in more detail below, the signal cdei is in this case a binary signal taking either the value 0 or the value 1 and used to place the multiplexer either in its first state or in its second state.

In the case illustrated in FIG. 2, the control signal SC sent by the control means MC1, which can be easily produced, for example, in the form of logic circuits, therefore includes a word of 3 bits, cde0, cde1, cde2. FIG. 5 illustrates the shifting of the input data DI to obtain the output data DO according to the shift value (control signal SC) in this case consisting of three bits. The shift value SC therefore varies in the present case from 0 (000) to 7 (111).

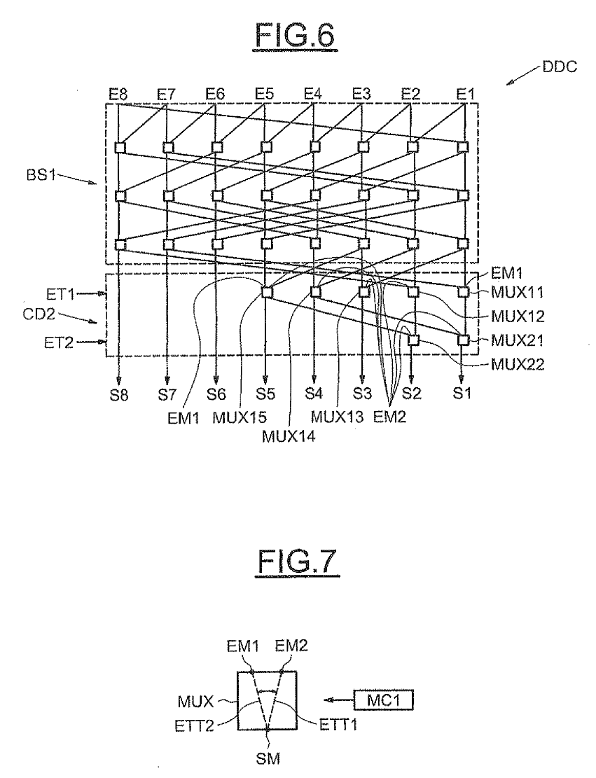

It is also possible to represent the configuration and the internal and external connection of the barrel shifter BS1 in the form of a graph as illustrated in FIG. 4, in which each multiplexer is represented by a square. This graph representation will be the one used hereinafter in the description, in the interests of simplicity. In addition to the barrel shifter BS1, the data shift device DDC comprises a second shifter CD2, one exemplary embodiment of which is illustrated in FIG. 6.

In practice, the second shifter is connected between some of the outputs of the barrel shifter BS1, that is, to the outputs SM of some of the multiplexers MUX of the shifter BS1, and some of the N outputs of the shift device, according to different predetermined organizations of data that can be received simultaneously on at least some of the N inputs of the data shift device. Moreover, this second shifter can be configured so that for a relevant organization, and regardless of the desired shift value compatible with the organization, the input data of the organization are delivered to predetermined outputs.

Moreover, a second controller or means MC2, which can also be produced, for example, in the form of logic circuits, can configure the second shifter according to the organization of the data that can actually be received as input as well as according to the desired shift value. It can henceforth be seen that, whereas the first control means MC1 will configure the barrel shifter BS1 only according to the desired shift value, and this regardless of the organization of the data received as input to the device (for example, their organization in a group and this regardless of the size of the group, or even their organization in several simultaneous groups), the second control means will configure the second shifter CD2 not only according to the desired shift value, but also according to the organization of the data that will actually be received as input.

Several possible exemplary configurations will now be described, but a few general characteristics concerning the second shifter CD2 can already be stated. Firstly, this second shifter also comprises multiplexers MUX (FIG. 7), similar to the multiplexers MUX of the barrel shifter BS1, and therefore having a first input EM1, a second input EM2 and an output SM1. It will be seen below that the shifter CD2 comprises at least one multiplexer stage. However, unlike the barrel shifter BS1, the multiplexers MUX of each stage of the shifter CD2 can be controlled separately by the control means MC2 whereas for the barrel shifter, all the multiplexers of one and the same stage are controlled identically.

It is now assumed that the data that can be received simultaneously as input to the device DDC are organized in a single group, the size of which is chosen from the size N and at least one predetermined intermediate size different to N and greater than 1. In practice, if the size N is not one of the predetermined sizes that can be handled by the device DDC, there is no need to provide a device with N inputs. A device of lesser size, the size of which is in fact equal to the maximum size of the group of data that can be received as input, will then be chosen.

The second shifter CD2 is then arranged and connected according to satheid predetermined intermediate size or sizes and the second control means MC2 are able to configure the second shifter CD2 according to the chosen size of the group of data that can actually be received as input and according to the desired shift value. More specifically, the second shifter CD2 comprises a number of shift stages equal to the number of predetermined intermediate sizes. Each shift stage is associated with a predetermined intermediate size and has a first state in which it is configured to perform a shift of at least one datum and a second state in which it is configured to shift no data.

Thus, the second control means are able to configure in its first state, the shift stage associated with the intermediate size of the group of data that can actually be received and then configure, for example, any other shift stages in their second state (or even in a third state as explained in greater detail below), or even configure each shift stage in its second state if the size of the group of data that can actually be received is equal to 1 or to N.

In practice, if the size of the group of data is equal to N, it is then the barrel shifter alone that will perform the shifting of the data according to the desired shift value, the second shifter then performing no shift and simply allowing the data to pass. Similarly, if, in a case, however theoretical, the group of data comprises only a single datum as input, it is obvious that no shift is performed for this datum whether by the barrel shifter or by the second shifter CD2.

The number of multiplexers that can be controlled separately in each shift stage of the second shifter CD2 depends on the predetermined intermediate size. In practice, each shift stage of the second shifter CD2 is associated with a predetermined intermediate size value p and then comprises p−1 individually controllable multiplexers (that can be controlled separately).

The output SM of each multiplexer is connected directly, or indirectly via a multiplexer of another stage, to one of the N outputs of the device. Moreover, the first input EM1 of each multiplexer is connected (directly or indirectly via another multiplexer of another stage) to the output of the barrel shifter having the same rank as the output of the device to which the output SM of the multiplexer is connected. In practice, the output of the barrel shifter concerned is the output SM of the last multiplexer of rank corresponding to the last stage of the barrel shifter.

The second input EM2 of each multiplexer MUX of the shifter CD2 is connected to another output of the barrel shifter, that is, to another output SM of a multiplexer of the last stage of the barrel shifter. Thus, each multiplexer has a first state ETT1 (FIG. 7) in which its output SM is connected to its second input EM2 which enables it to perform a data shift, and a second state ETT2 in which its output is connected to its first input EM1 which enables it to perform no data shift. Because of this, when a shift stage of the shifter CD2 is in its first state, that is, when it has to shift at least one datum, at least one multiplexer MUX of this stage is in its first state. However, when the shift stage is in its second state, that is, it simply allows the data to pass without shifting them, all the multiplexers of this stage are in their second state.

Reference is now made again more particularly to FIG. 6 which illustrates the particular case of a circuit DDC capable of handling three different predetermined bus sizes (in addition to the theoretical case of a size equal to 1), namely an intermediate size p equal to 3, an intermediate size p equal to 6 and a size equal to N, in this case equal to 8. In other words, the data bus which is linked to the eight inputs E1 to E8 can simultaneously deliver a group of eight data, or a group of three data, or a group of six data.

Moreover, in the case illustrated in FIG. 6, the device is configured for a left shift, the p input data are received on the p inputs E1-Ep of ranks 1 to p and the p output data (corresponding to the size of the group) are delivered, regardless of the envisaged shift value, to the p outputs S1 to Sp. Naturally, if the size is equal to N, the N data are received on the inputs E1 to EN and the N output data are delivered on the outputs S1 to SN.

The second shifter CD2 consequently comprises two shift stages ET1 and ET2 since it can handle two different intermediate sizes, namely the size 3 and the size 6. The first stage ET1 is associated with the size 6 and consequently comprises five multiplexers MUX11 to MUX15. The second shift stage ET2 is associated with the intermediate size equal to 3 and consequently comprises two multiplexers MUX21 and MUX22.

In the present case, since it concerns a left shift and the predetermined outputs are the outputs S1 to Sp, the p−1 multiplexers of each stage are linked to the p−1 predetermined outputs S1 to Sp−1. Moreover, the outputs of the (min(2p−1, N)−p) multiplexers of rank p+1 to min (2p−1, N) of the last stage of the barrel shifter BS1 are respectively linked to the second inputs of the (min (2p−1, N)−p) multiplexers of rank 1 to (min (2p−1, N)−p) of each stage of the shifter CD2 (min (a,b) here denotes the minimum of a and b).

Moreover, if N is less than 2p−1, the second inputs EM2 of the 2p-N−1 other multiplexers of the 4 stage are respectively linked directly or indirectly to the outputs of the 2p-N−1 multiplexers of rank 1 to 2p-N−1 of the last stage of the barrel shifter BS1. Thus, in the present case, the second inputs EM2 of the multiplexers MUX11 and MUX12 are linked to the last two multiplexers of rank 7 and 8 of the last stage of the barrel shifter BS1 whereas the multiplexers MUX13 to MUX15 are respectively linked to the outputs of the first three multiplexers of rank 1 to 3 of the last stage of the barrel shifter BS1.

Regarding the stage ET2, since in the present case p is equal to 3, the only two multiplexers MUX21 and MUX22 of this stage ET2 are indirectly linked via the multiplexers MUX14 and MUX15 to the multiplexers of ranks 4 and 5 of the last stage of the shifter BS1.

Regarding the control of the different multiplexers of the shifter CD2, when the shift device DDC is in mode 6, that is, when the device is intended to receive successive groups of six data, the control means MC2 will place the stage ET2 in its second state and will separately control the multiplexers MUX11 to MUX15 of the stage ET1, and this according to the desired shift value S. Naturally, the first control means MC1 will configure the barrel shifter BS1 according to this desired shift value.

Regarding the control of the multiplexers of the stage ET1 of the shifter CD2, it is, in the example of FIG. 6, as follows: for a shift value S equal to 0, the multiplexers MUX11 to MUX15 are in their second state, that is, they do not shift; for a shift value S equal to 1, only the multiplexer MUX11 is in its first state, that is, its output is linked to its second input EM2 (that is, the input that receives a datum indirectly); when the shift value S is equal to 2, only the multiplexers MUX11 and MUX12 are in their first state and so on up to a shift value S equal to 5 for which all the multiplexers MUX11 to MUX15 are in their first state.

In practice, for such a configuration, for a given shift value S less than the value p of the intermediate size concerned, all the multiplexers of the stage are in their second state for a zero value S and only the multiplexers of rank S are in their first state for a non-zero value S. If, now, the shift device DDC is in mode 3, that is, the size of the groups of data successively received as input is equal to 3, only the stage ET2 will be active, that is, all the multiplexers of the stage ET1 will be in their second state. Also, the two multiplexers MUX21 and MUX22 of the stage ET2 will be controlled separately according to the desired shift value (which in the present case can be equal to 0, 1 or 2) according to the same principle as that just stated above.

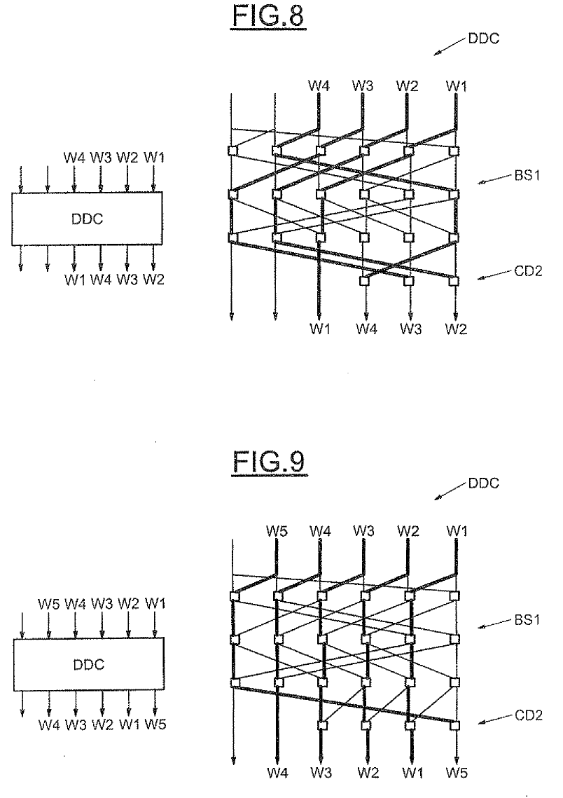

Other configuration and control examples of the circuit DDC will now be described with reference to FIG. 8 and following, for which, for an intermediate size p, the input data are, once again, received on the inputs E1 to Ep. In FIG. 8, the device DDC has a maximum size N equal to 6 and it is arranged so as to be able also to handle an intermediate size p equal to 4. The stage CD2 therefore comprises only a single stage with three multiplexers. In the example of FIG. 8, the predetermined outputs are, once again, the outputs S1 to S4 when the intermediate size 4 is actually chosen, and this regardless of the shift value.

In the example illustrated in FIG. 8, the shift value S is equal to 3 and the right-hand part of FIG. 8 illustrates in bold characters the different states of the different multiplexers enabling the input data W1-W4 to be shifted so as to deliver on the output S4 the datum W1 and on the outputs S3 to S1 the data W4, W3 and W2.

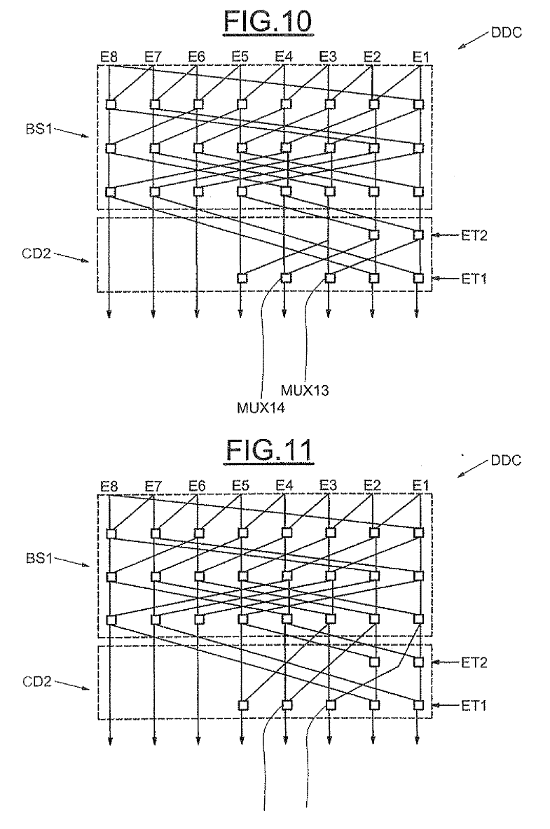

In the example of FIG. 9, the device DDC again has a maximum size N equal to 6. However, it is configured also to be able to handle an intermediate size p equal to 5. The shifter CD2 therefore comprises only a single stage with four multiplexers. Here, again, the p predetermined outputs are the outputs S1 to S5. And, for a shift value S equal to 1, the shifters BS1 and CD2 are configured as illustrated with the bold lines in FIG. 9. The arrangement of the shift stages within the second shifter CD2 is unimportant. In practice, as illustrated in FIG. 10, it is possible to reverse the order of the stages ET1 and ET2 relative to the configuration illustrated in FIG. 6, employing the same connections between the different multiplexers, which is the case in FIG. 10.

Moreover, whereas in FIG. 10 some of the multiplexers of the stage ET1, in this case the multiplexers MUX13 and MUX14, have their second input connected to the outputs of the two multiplexers of rank 1 and 2 of the last stage of the shifter BS1, via the two multiplexers of the stage ET2, it would be possible, as illustrated in FIG. 11, to connect the second inputs of these multiplexers MUX13 and MUX14 directly to the outputs of the multiplexers of ranks 1 and 2 of the last stage of the barrel shifter BS1, that is, without involving the multiplexers of the stage ET2.

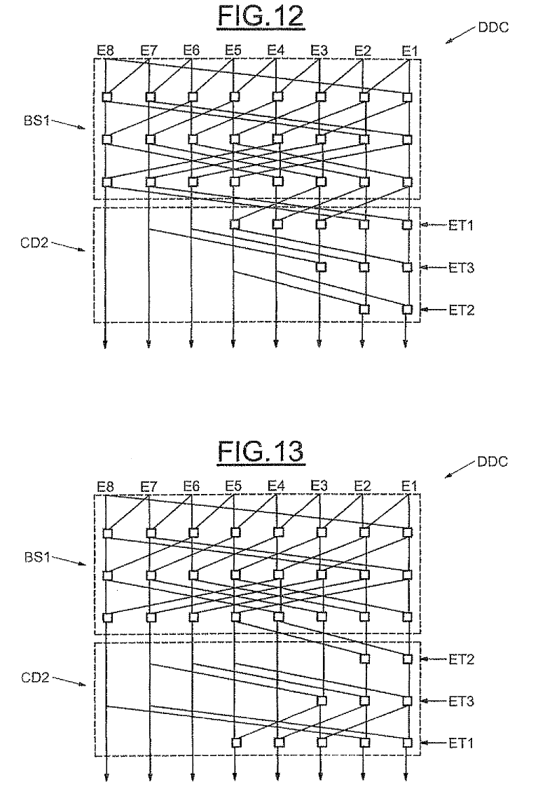

FIG. 12 this time illustrates an exemplary multimode shift device DDC, capable of handling buses of sizes 8, 6, 4, 3 and, of course, 1. Consequently, as explained above, the second shifter CD2 will this time comprise three shift stages respectively associated with the intermediate sizes 3, 4 and 6. The two stages ET1 and ET2 are therefore respectively associated with the sizes 6 and 3. However, the shifter CD2 now comprises another stage, in this case the stage ET3, associated with the intermediate size 4 and consequently comprising three multiplexers. Since, once again, the predetermined outputs on which the shifted data will be delivered are, for a given size p, the outputs S1 to Sp, the three multiplexers of the stage ET3 are connected and controlled according to the same principle as that indicated above for FIG. 6. Naturally, here too, the order of arrangement of the stages ET1 to ET3 is unimportant. In practice, it is possible to adopt the order and the connection illustrated in FIG. 13, in which the stages are arranged in ascending order of the number of multiplexers.

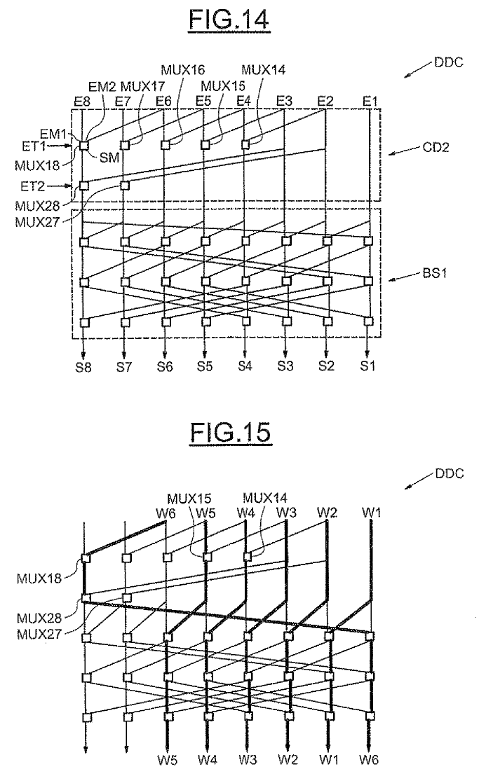

In the examples that have just been described, the second shifter CD2 was connected downstream of the barrel shifter BS1. That said, it is perfectly possible to envisage, as illustrated for example in FIGS. 14 to 19, connecting the shifter CD2 upstream of the barrel shifter BS1. In other words, in this case, the second shifter CD2 is connected between some of the inputs E1 to EN of the device DDC and some of the inputs of the barrel shifter according to different predetermined organizations of data that can be received simultaneously on at least some of the inputs of the shift device DDC.

In practice, in such an upstream placement, only the arrangement and the connections of the second shifter CD2 are modified according, in particular, to the organization of the input data. However, the above explanation concerning the number of shift stages relative to the intermediate sizes, and concerning the number of multiplexers per shift stage, remains valid for such an upstream placement.

More specifically, as illustrated for example in FIG. 14, each multiplexing means MUX has a first input EM1 connected to an input of the device, an output SM connected to the input of the barrel shifter BS1 having the same rank as the input of the device and a second input EM2 connected to another input of the device DDC, that is, indirectly connected in the representation of FIG. 14. In the case illustrated in FIG. 14, the p input data corresponding to an intermediate size p are delivered to the p inputs E1-Ep of ranks 1 to p.

Moreover, the p output data are, once again, delivered to the p predetermined outputs S1-Sp. Naturally, once again, if the size of the input bus is actually equal to N, the N input data are received on the inputs E1 to EN and the N output data are delivered on the outputs S1 to SN. Moreover, a shift stage associated with the intermediate size p comprises p−1 multiplexers, the first inputs EM1 of which are respectively linked to the p−1 inputs of the device DDC of rank N to N-p+2. Moreover, the second inputs EM2 of each multiplexer are respectively linked to the p−1 inputs of the device DDC of ranks p to 2.

Thus, in the example of FIG. 14 which illustrates a device DDC of maximum size N, capable of performing a left shift, and capable of handling, in addition to the theoretical size 1, two intermediate sizes p respectively equal to 6 and 3, the device DDC comprises two shift stages ET1 and ET2. The first inputs EM1 of the five multiplexers MUX18-MUX14 of this stage are respectively linked to the inputs E8 to E4. Moreover, their second inputs EM2 are respectively linked to the inputs E6 to E2. Their outputs are directly or indirectly linked to the inputs of the barrel shifter BS1 having the ranks 8 to 4. Similarly, the two multiplexers MUX28 and MUX27 of the stage ET2 are placed at the level of the ranks 8 and 7 and their second inputs EM2 are respectively linked to the inputs E3 and E2 of the device DDC.

The second control means MC2 which have not been represented in FIG. 14 in the interests of simplicity, will control the multiplexers of a stage ETi associated with the intermediate size p in the following way: for a given shift value S less than the value p, only the multiplexers of rank N to N-S+1 are in their first state, that is, in their shift state (they take the input datum indirectly); any multiplexers of rank p-S to 2 are in their second state, that is, they do not shift. The state of any other multiplexers of the shift stage is unimportant because, in any case, given the control of the barrel shifter, any data passing through these multiplexers will not be delivered on the outputs S1 to Sp. Regarding any other stages of the shifter CD2, the control of their multiplexers depends in fact on the placement of this stage relative to that of the stage associated with the intermediate size of the group of data that is actually received as input to the circuit DDC.

In practice, if this other stage is placed between the inputs of the device DDC and the stage associated with the intermediate size p of the group actually received, this other stage will normally be placed in its second state, that is, in a state in which all the multiplexers do not shift.

However, if this other stage, for example the stage ET2 of the circuit DDC, is disposed between the stage associated with the intermediate size p of the group actually received and the barrel shifter BS1, this other stage can be placed either in its second state (in which all the multiplexers do not shift) or indeed in a third state (in which only some of the multiplexers do not shift, bearing in mind that the state of the other multiplexers is then unimportant since any data passing through these multiplexers will in any case be switched to outputs other than the predetermined outputs). And, normally, at least the multiplexers of this stage, the first input EM1 of which is linked to the output of the multiplexers of the preceding stage through which the input data have actually passed, will be placed in their second state.

Examples of operation of the device DDC in FIG. 14 will now be described with reference to FIGS. 15 to 19. In FIGS. 15 to 17, the intermediate size of the group of data simultaneously received as input is equal to 6. The data W1 to W6 are received on the inputs E1 to E6 and the data from the outputs are delivered on the outputs S1 to S6. These three figures illustrate a left shift. In FIG. 15, the shift value S is equal to 1. Because of this, only the multiplexer MUX18 is in its shift state whereas the multiplexers MUX14 and MUX15 do not shift. The state of the other multiplexers of the stage ET1 is unimportant. Similarly, only the multiplexer MUX28 of the stage ET2 must not shift. However, the state of the multiplexer MUX27 is unimportant. The stage ET2 is therefore in its third state.

In FIG. 16, the shift value is equal to 2. Consequently, the multiplexers MUX17 and MUX18 are in their first state (shift state) whereas the multiplexer MUX14 is in its second state (it does not shift). The two multiplexers MUX28 and MUX27 of the stage ET2 must be in their second state (that is, not shift). The stage ET2 is therefore in its second state.

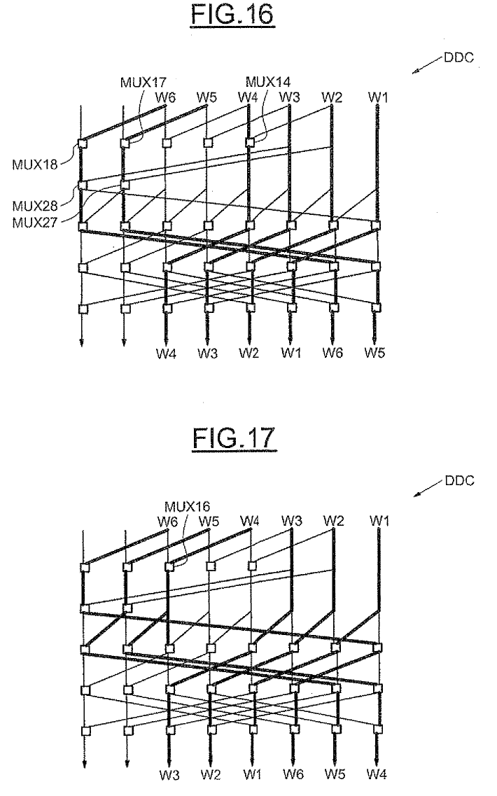

In FIG. 17, the shift value S is equal to 3. Compared to the configuration of FIG. 16, the only change here lies in the fact that the multiplexer MUX16 of the stage ET1 is also in its shift state.

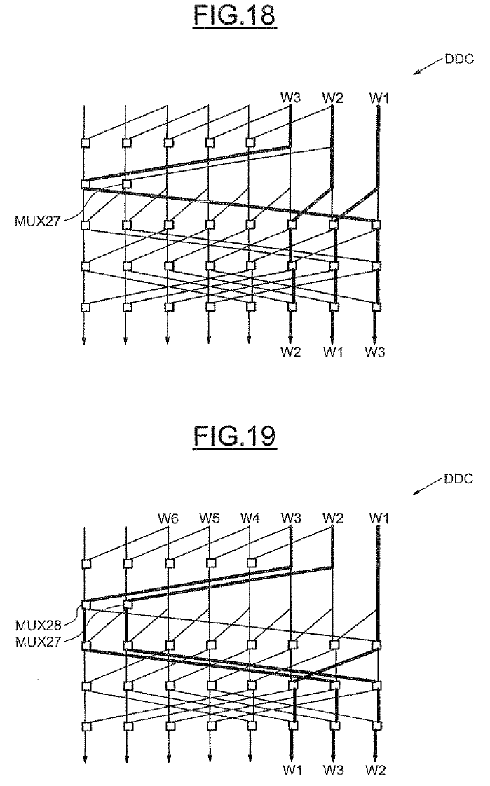

In FIGS. 18 and 19, the intermediate size of the group of data simultaneously received as input is this time equal to 3. The illustration is, once again, of a left shift.

In FIG. 18, the shift value S is equal to 1. Because of this, only the multiplexer MUX28 of the stage ET2 is in its first shift state. The state of the multiplexer MUX27 is unimportant.

In FIG. 19, the shift value S is equal to 2. In this case, the two multiplexers MUX27 and MUX28 of the second stage ET2 are in their first shift state. In the present case, since only three data are received as input to the device DDC, the state of the multiplexers of the stage ET1 is unimportant. However, if data had to pass through this stage, and since the latter is placed between the inputs of the device and the shift stage actually associated with the intermediate size of the group of data that is received, this stage would advantageously be placed in its second state, that is, it would shift no data.

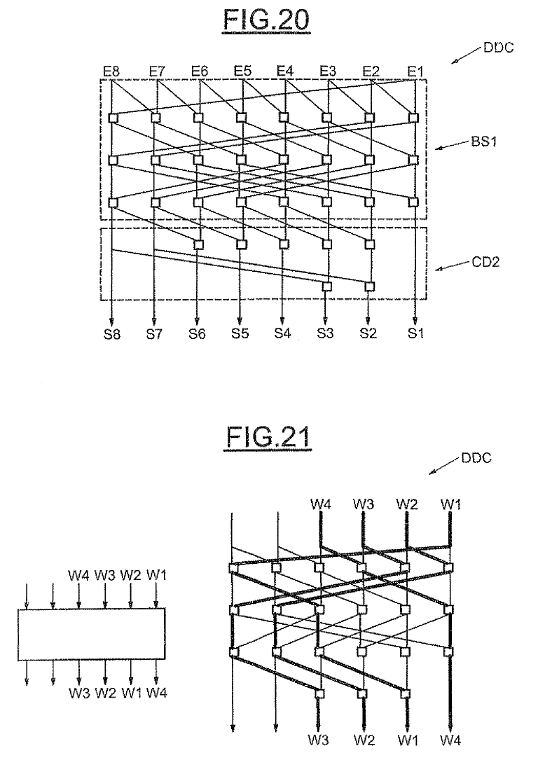

Although data shift devices have just been described that are configured to perform left shifts, it is quite possible to provide data shift devices DDC capable of performing right shifts. One example of such a configuration is illustrated in FIG. 20. The structure and the configuration of a barrel shifter BS1 capable of right shifting is, once again, well known and conventional and will not be described in more detail here.

Regarding the second shifter CD2 which is here connected downstream of the shifter BS1, the characteristics relating to the number of shift stages and to the number of multiplexers are similar to those that have just been described for a left shift. In practice, only the connection and the control of the multiplexers change according, in particular to the choice of the predetermined outputs on which the shifted data will be delivered.

In the example of FIG. 20, the device DDC has a maximum size equal to 8 and is capable also of handling two intermediate sizes respectively equal to 6 and to 3. The predetermined outputs are, once again, for an intermediate size p, the outputs S1 to Sp, and the input data are received on the inputs E1 to Ep. That said, for a right-shift configuration, and given the choice of predetermined outputs, the p−1 multiplexers of a shift stage of the shifter CD2 are respectively connected to the outputs of ranks 2 to p. Moreover, the second inputs of the multiplexers of the corresponding shift stage are respectively connected to the outputs of the p−1 multiplexers of ranks N-p+2 to N.

The control of the multiplexers is also handled separately. As an example, FIG. 21 illustrates a configuration and a control of the multiplexers of a shifter DDC that can right shift, having a maximum size N=6 and handling an intermediate size equal to 4 with a shift value S equal to 3.

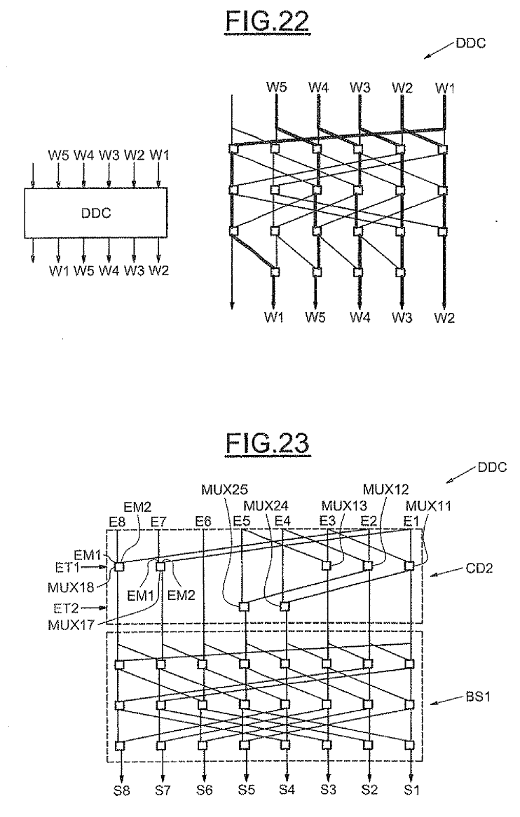

FIG. 22 illustrates a configuration of a data shift device able to perform a right shift, having a maximum size equal to 6 and handling a bus of intermediate size 5 with a shift value equal to 1. FIG. 23 illustrates one exemplary embodiment of a device DDC capable of performing a right shift but this time with a second shifter CD2 placed upstream of the barrel shifter BS1. Once again, the data are received on the inputs E1 to Ep, for a given intermediate size p, and the predetermined outputs are the outputs S1 to Sp.

The first inputs EM1 of the p−1 multiplexers of each stage ETi are respectively connected to p−1 inputs of rank p+1 and following with, in the case where the value N is reached, a connection to the ranks 1 and following. Moreover, the second inputs EM2 of these p−1 multiplexers are respectively linked to the inputs of ranks 1 to p−1. Thus, in the case illustrated in FIG. 23, the stage ET1 associated with the intermediate size p 6 comprises five multiplexers MUX11, MUX12, MUX13, MUX17, MUX18.

The first inputs EM1 of the multiplexers MUX17 and MUX18 are respectively linked to the inputs E7 and E8 whereas the first inputs EM1 of the multiplexers MUX11 to MUX13 are respectively linked to the inputs E1 to E3. The second inputs EM2 of the multiplexers MUX17, MUX18, MUX11, MUX12 and MUX13 are respectively linked to the inputs E1, E2, E3, E4 and E5.

Regarding the stage ET2, which is associated with the intermediate size p=3, it comprises two multiplexers MUX24 and MUX25, the first inputs EM1 of which are connected to the inputs E4 and E5 and the second inputs EM2 of which, that is, in this case, the indirect inputs, are indirectly linked, via the outputs of the multiplexers MUX11 and MUX12, to the inputs E1 and E2.

Regarding the separate control of the multiplexers, this depends on the desired shift value. The higher this shift value is, the greater the number of multiplexers there are placed in their first state (shift state) in the stage concerned.

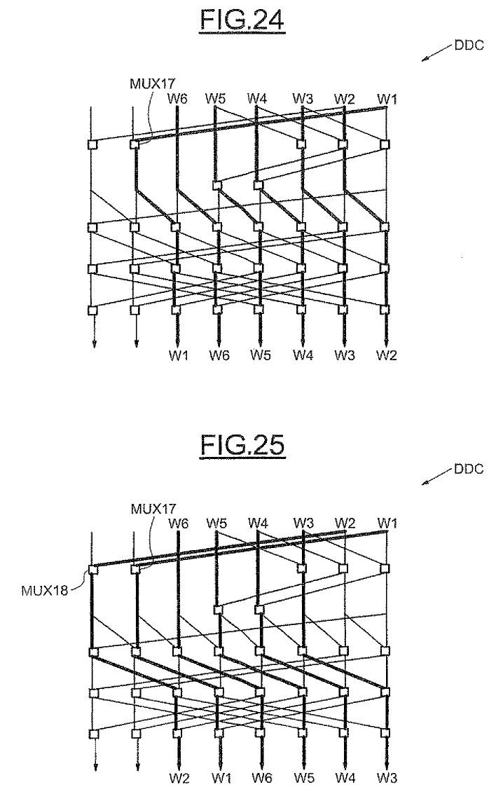

Thus, for a shift value S=1, only the multiplexer of rank p+1 will be in its shift state whereas, for a value S=2, the multiplexers of ranks p+1 and p+2 will be in their shift state, and so on. This is illustrated more particularly in FIGS. 24 to 26. In FIG. 24, the right-shift value is equal to 1. Because of this, only the multiplexer MUX17 is in its first shift state. The other multiplexers of the stage ET1 are in their second state, except for those connected to the inputs E1 and E8, the state of which is unimportant.

Moreover, all the multiplexers of the stage ET2, through which data received as input pass, are in their second state (that is, they do not shift).

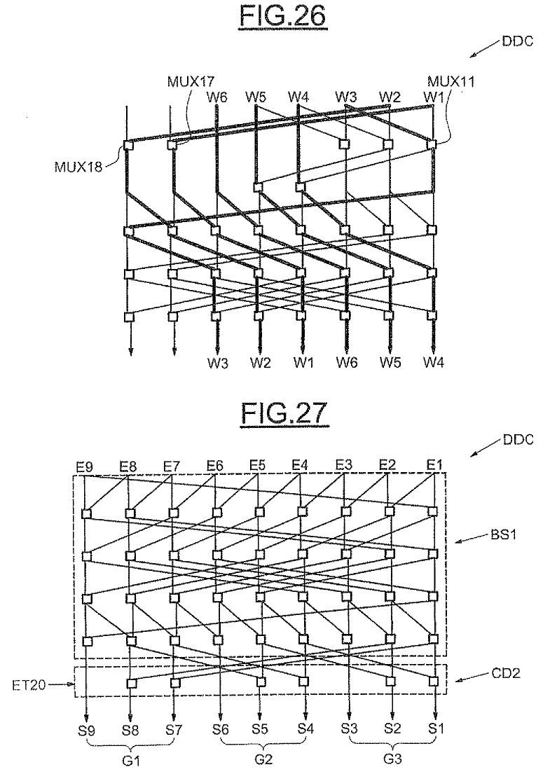

In FIG. 25, the shift value S is equal to 2. Therefore, the multiplexers MUX17 and MUX18 are in their shift state. In FIG. 26, the shift value is equal to 3 and, consequently, the multiplexers MUX11, MUX17 and MUX18 are in their shift state.

In everything that has been described above, it has been assumed that the data were coded on a single bit. That said, the invention also applies to data coded more generally on several bits. In this case, if the data are coded on a number nbit, each multiplexer MUX is in fact replaced by a set of nbit multiplexers in parallel and each connected identically.

The number of multiplexers of the shifter DDC is equal to NbMUX which is given by the following formula:

$$NbMUX = nbit \times ( ceil ( log 2 ( N ) ) \times N + {\sum }_{K ∈ mode , k \neq N} ( k - 1 ) )$$

In this formula, the term “mode” in fact denotes all the intermediate sizes that can be handled by the device. Thus, if the device is intended to handle all the sizes from 1 to N, the number of multiplexers is then given by the following formula:

$$( N \times ceil ( log 2 ( N ) ) + \frac{( N - 1 ) \times ( N - 2 )}{2} ) \times nbit$$

In fact, as has been seen previously, the arrangement and the configuration, as well as the control of the various multiplexers of the second shifter, depend not only on the number of intermediate sizes that can be handled, but also on the choice of the inputs on which the p input data are received and the choice of the predetermined outputs of the shift device for an intermediate size p. In practice, it is quite possible to envisage having the data output for an intermediate size p out of p outputs, by all means predetermined, regardless of the desired shift value, but different from the outputs S1 to Sp. Similarly, it is possible to have the p input data received on p different inputs of the inputs E1 to Ep.

Similarly, the concept of third state for a shift stage, which has been described above in the case of a connection of the shifter CD upstream of the barrel shifter, can also apply in the case of a downstream connection. For example, in the configuration illustrated in FIG. 10 and with a size p equal to 3, the stage ET2 is in its first state whereas the stage ET1 can be in its third state because two multiplexers of this stage ET1 have an immaterial state. Only the multiplexers of this stage ET1 through which the data pass are in their second state.

More generally, the control of the stages in their second or their third state depends in particular on the intermediate sizes but also on the relative arrangements of the different stages. Those skilled in the art will therefore be able to configure on a per-case basis the second shifter and connect it to the shifter BS1 according to the planned application, naturally employing the general principles stated above and relating to the number of shift stages, and to the number of multiplexers per shift stage, and naturally employing a control of the multiplexers of the second shifter CD2, separately.

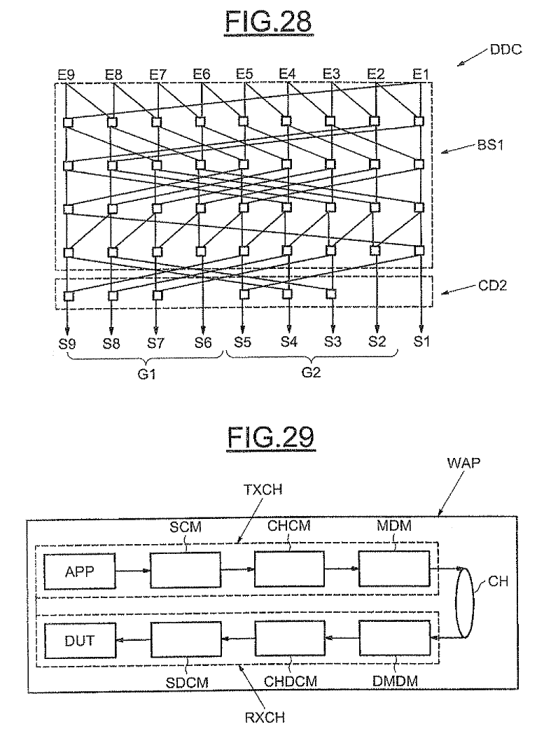

In the examples that have just been described, it has been assumed that the data simultaneously received as input to the device DDC were organized in a single group, the size of which could be chosen from a certain number of predetermined sizes. It is quite possible, as a variant, for these data to be organized in different organizations. Thus, as illustrated for example in FIGS. 27 and 28 which concern a connection of the shifter CD2 downstream of the shifter BS1, the data that can be received simultaneously as input to the device can be organized either in a single group of size N or in several groups, each having the same intermediate size chosen from at least one of the predetermined intermediate sizes different to N and greater than 1.

The second shifter CD2 is then arranged and connected according to the predetermined intermediate size or sizes and the number g of groups. The second control means are then able to configure the second shifter according to the chosen size of the group or groups of data that can actually be received and according to the desired shift value, which is the same in the case of several groups of data received simultaneously.

In practice, the general principles that have been described above with reference to the preceding figures for the organization in a single group of data, here apply in a roughly similar way. More specifically, the shift stage associated with an intermediate size value p comprises g groups of p−1 multiplexers that can be controlled separately and the control means can separately control each multiplexer of a group of the shift stage concerned according to the desired shift value and identically control the peer multiplexers of the g groups. Naturally, the sum of the data of each group must not exceed N and the number of data in each group is the same for all the groups.

The example of FIG. 27 is a data shifter able to perform a left shift and which has a size N=9. This shifter is therefore capable of handling a group of nine data, or even as illustrated in this example, three groups of three data, the intermediate size therefore being in this case equal to 3. The shift value, the same for all three groups, is between 0 and 2. Also, the three groups of data can be shifted simultaneously with the same shift value. The first group G1 of shifted data is therefore delivered on the predetermined outputs S7 to S9 whereas the second G2 is delivered on the outputs S4 to S6 and the third group on the outputs S1 to S3.

Here too, those skilled in the art will be able to establish the control law applicable to the multiplexers according to the desired shift value. The second example described is illustrated in FIG. 28. It concerns a data shift device of size N=9 capable of performing a right shift and capable of also handling two groups of four data. It therefore comprises a single shift stage comprising two groups of three multiplexers (or sets of multiplexers in the case where the data are coded on nbit).

The first group G1 is delivered on the outputs S6 to S9 regardless of the shift value and the second group G2 is delivered on the outputs S2 to 55 regardless of the shift value. With such an organization, the number of multiplexers is given by the formula below:

NbMUX=nbit×(ceil(log2(N))×N+nb_groups×(k−1))

in which nb_groups denotes the number of groups.

Naturally, it is quite possible, even when there are several groups of data, to place the second shifter CD2 upstream of the barrel shifter. In these conditions, the same principles will be applied as those that have just been described with reference to FIGS. 27 and 28 with respect to the groups of multiplexers, and also by analogy the control and connection principles of the multiplexers that have been described with reference to FIGS. 14 to 19 for a left shift and 23 to 26 for a right shift will also be applied.

The invention can advantageously be applied in the context of systems operating according to wireless transmission standards such as, for example, the IEEE 802.16e standard intended for systems called “Fixed and Mobile Broadland Wireless Access Systems” or even the IEEE 802.11n standard regarding networks called “Local and Metropolitan Networks”. The DVB-S2 standard can also be cited, in particular for satellite transmissions. Such systems use channel coding and decoding means which can advantageously incorporate shift devices as described above.

More specifically, in FIG. 29, the reference WAP denotes a wireless appliance that can be used in a communication system compliant with the DVB-S2 standard. The wireless appliance WAP comprises a transmission subsystem TXCH capable of transmitting coded and modulated information over a transmission channel CH, for example the air. Moreover, this appliance WAP also comprises a reception subsystem RXCH capable of receiving and decoding information originating from the transmission channel CH.

The transmission subsystem TXCH conventionally and in a manner known per se comprises source coding means SCM receiving application data APP in particular to compress them so as to reduce the data rate. The transmission subsystem also comprises channel coding means, the function of which is in particular to add redundancy to be able subsequently to correct potential errors in reception due to the transmission channel noise. These channel coding means comprise, for example, LDPC coding means.

The transmission subsystem also comprises modulation means MDM so as to adapt the signal to the transmission channel (satellite channel or radio channel, for example). The reception subsystem RXCH comprises similar means performing the reverse functions. More specifically, there are demodulation means DMDM, followed by channel decoding means CHDCM comprising, for example, an LDPC decoder, followed by source decoding means SDCM delivering to the user the user data DUT corresponding to the application data APP.

The LDPC code is a block-based code. The encoder processes blocks of K bits and delivers blocks of N bits. Thus, N-K redundancy bits are added. These N-K bits are called “parity bits”. The code rate is defined by the ratio K/N. The lower the code rate is, the greater the number of redundancy bits there are and also the greater the protection there is against transmission channel noise.

These N-K bits are calculated using a parity matrix H. The LDPC code is therefore also a code based on a matrix. This matrix has N-K rows and N columns and consists of 1s and 0s with a low number of 1s compared to the number of 0s. This is why this type of code based on such a matrix is called “LDPC code”, that is, low density code. The encoded block BLC, on N bits, is calculated by solving the equation HBLC^{T}=0, where H denotes the parity matrix and T the “transpose” function.

On the decoder side, the correction of the errored bits is performed based on the relationships between the coded information of the block. These relationships are given by the parity matrix H. The decoder uses internal metrics corresponding to the is of the matrix H. The matrix H corresponds to the Tanner graph of the LDPC code comprising nodes called “check nodes” and information nodes called “bit nodes” interlinked by the path of the graphs representative of the messages exchanged iteratively between the duly linked nodes. These metrics are updated in rows (updating of the check nodes) by taking account of the internal metrics of one and the same row. Then, the decoder updates these metrics in columns (updating of the bit nodes) by taking into account the internal metrics on one and the same column and the corresponding bit at the input of the decoder and originating from the transmission channel. One iteration corresponds to the updating of the check nodes for all the internal metrics followed by the updating of the bit nodes for all the internal metrics.

Decoding a block takes several iterations. The values of the decoded bits, also called “hard decisions”, are obtained by adding together the internal metrics by columns with the bits received and by taking the sign of the result. In other words, the sign of the result supplies the value “0” or “1” for the bit, whereas the absolute value of the result gives a confidence indication (probability) for this logic “0” or “1” value.

The codes of the LDPC type are interesting in that they make it possible to obtain a bit error rate (BER) that is very low, because of the iterative nature of the decoding algorithm. Several iterative decoding algorithms exist for decoding LDPC codes. The conventional so-called “Belief Propagation” algorithm (BP), well known to those skilled in the art, can in particular be cited.

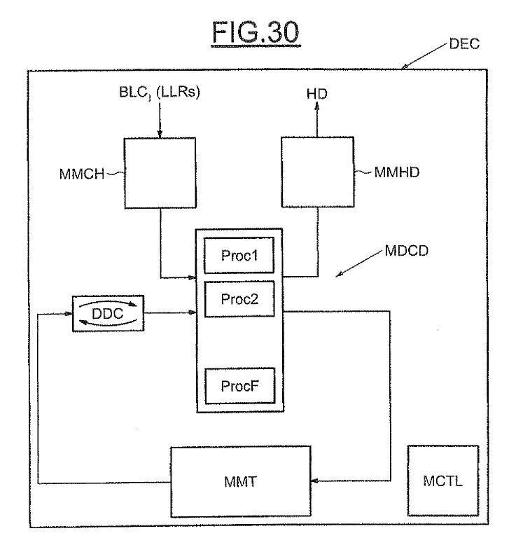

To refer now more particularly to FIG. 30, this shows how an exemplary LDPC decoder, referenced DEC, mainly and diagrammatically comprises input memory means MMCH, decoding means MDCD, output memory means MMHD and check means MCTL. The input memory means MMCH receive a succession of blocks BLCᵢ encoded with an LDPC code. Each block comprises a predetermined number of coded information items, 64 800 in the DVB-S2 standard.

These information items are in fact probability ratios and are normally known to those skilled in the art as Log Likelihood Ratios (LLR). These information items are encoded on n bits. The sign of each information item is representative of its logic value whereas its absolute value is representative of the confidence that the logic value of this information item is the right one.

Each received block BLCᵢ is decoded in the decoding means MDCD comprising, in this example, F processors operating in parallel, F being equal to 360 in a DVB-S2 standard application. The battery of F processors updates the check nodes and the bit nodes. A metrics memory MMT contains the internal metrics (of a number equal to the number of 1s in the parity matrix).

A shift device DDC as described above can be used to place the right data alongside the right processors. In the iterative decoding, the channel information, initialized by the information from the block to be decoded, is updated using the updated metrics. Finally, on completion of the decoding, the processors deliver into the memory MMHD, the hard decisions corresponding to the decoded logic values of the block BLCᵢ. These hard decisions are in fact the signs of the channel information updated on the last iteration.

The use of a shift device DDC as described above, whether within the channel coding means or channel decoding means, makes it possible to reduce the footprint and the number of multiplexers.

In practice, as an example, in the 802.11n standard, the bus sizes that need to be able to be handled are equal to 81, 54 and 27. The use of a conventional barrel shifter of size 81 leads to a number of multiplexers equal to 3402 with data coded on 6 bits. A barrel shifter of size 54 comprises 1944 multiplexers. A barrel shifter of size 27 has 810 multiplexers.

Consequently, an option to provide three conventional barrel shifters having respectively a size equal to 81, 54 and 27 to be able to support the three sizes required by the 802.11n standard leads to a total number of multiplexers equal to 6156 to which must be added a selection circuit. By contrast, a data shift device according to one embodiment of the invention having a maximum size equal to 81 and capable of handling the two intermediate sizes 54 and 27 using the second shifter CD2 leads to a total number of multiplexers of 3876 (with data coded on 6 bits).

Regarding the 802.16e standard, the number of modes is far greater, typically equal to 19. More specifically, the size of the data bus can vary from 24 to 96. Also, as an indication, with data coded on 6 bits, the size of a standard barrel shifter of size 96 and therefore capable of covering only a single mode, namely the maximum mode, has a total number of multiplexers equal to 4032.

As a comparison, a data shift device like the one described above and which would be capable of covering all 19 possible modes of the 802.16e standard would have a footprint scarcely three times greater than that of the conventional barrel shifter capable of handling just one mode and a number of multiplexers less than three times the number of multiplexers of the same conventional barrel shifter.

1-24. (canceled)

25. A data shift device comprising:
a plurality of inputs;
a plurality of outputs;
a configurable barrel shifter connected between the inputs and the outputs;
a first controller to configure the barrel shifter according to a shift value;
a second shifter arranged and connected to the configurable barrel shifter according to different organizations of data to be respectively received simultaneously on the inputs and configurable so that, for a given organization and regardless of a shift value compatible with the organization, the corresponding input data are delivered to outputs; and
a second controller to configure the second shifter according to the given organization of the data that can be received and according to the shift value.

26. The data shift device according to claim 25, wherein the plurality of inputs comprises N inputs and wherein the plurality of outputs comprises N outputs; wherein the data that can be received simultaneously on the inputs are organized in a single group, the size of which is one of a size N and at least one predetermined intermediate size that is different from N and greater than 1; wherein the second shifter is arranged and connected according to the at least one predetermined intermediate size, and the second controller configures the second shifter according to the size of the group of data that can be received and according to the shift value.

27. The data shift device according to claim 26, wherein the second shifter comprises a plurality of shift stages equal to a number of predetermined intermediate sizes, each shift stage being associated with a predetermined intermediate size.

28. The data shift device according to claim 27, wherein the second shifter is connected between the barrel shifter and at least some of the outputs according to the different organizations of data that can be received on the inputs.

29. The data shift device according to claim 28, wherein each shift stage has a first state in which it is configured to perform a shift of at least one datum and a second state in which it is configured to shift no data; and wherein the second controller configures in the first state one of the shift stages associated with the intermediate size of the group of data that can be received, and configures the other shift stages in the second state; and wherein the second controller configures each shift stage in its second state when the size of the group of data that can be received is equal to one of 1 and N.

30. The data shift device according to claim 28, wherein each shift stage has a first state in which it is configured to perform a shift of at least one datum, a second state in which it is configured to shift no data and/or a third state in which it is configured to perform no shift of at least some of the data; and wherein the second controller configures in the first state one of the shift stages associated with the intermediate size of the group of data that can be received, configures the other shift stages in one of the second state and third state, or configures each shift stage in the second state when the size of the group of data that can be received is equal to one of 1 and N.

31. The data shift device according to claim 30, wherein the shift stage associated with the intermediate size having a value p comprises p−1 multiplexing units that can be controlled individually; wherein each multiplexing unit has an output connected to one of the N outputs of the device, a first input connected to the output of the barrel shifter associated with the output of the device and a second input connected to another output of the barrel shifter, and each multiplexing unit has a first state in which its output is connected to its second input, and a second state in which its output is connected to its first input; and wherein at least one multiplexing unit is in its first state when the shift stage is in its first state, and each of the multiplexing units of the shift stage is in its second state when the shift stage is in its second state, and at least some of the multiplexing units are in their second state when the shift stage is in its third state.

32. The data shift device according to claim 27, wherein the second shifter is connected between some of the inputs and the barrel shifter according to the different organizations of data that can be received simultaneously on at least some of the inputs.

33. The data shift device according to claim 32 taken in combination, wherein each shift stage has a first state in which it is configured to perform a shift of at least one datum, a second state in which it is configured to shift no data and/or a third state in which it is configured to perform no shift of at least some of the data; and wherein the second controller configures in the first state a shift stage associated with the intermediate size of the group of data that can be received, configures in the second state each shift stage disposed between the inputs of the device and the shift stage associated with the intermediate size of the group of data that can be received, configures in one of the second and third state each shift stage disposed between the shift stage associated with the intermediate size of the group of data that can be received and the barrel shifter, or configures each shift stage in its second state when the size of the group of data that can be received is equal to one of 1 and N.

34. The data shift device according to claim 33, wherein the shift stage associated with a predetermined intermediate size having a value p comprises p−1 multiplexing units that can be controlled separately, each multiplexing unit having a first input connected to an input of the device, an output connected to an input of the barrel shifter associated with the input of the device and a second input connected to another input of the device, each multiplexing unit having a first state in which the output is connected to the second input, and a second state in which the output is connected to the first input, and at least one multiplexing unit is in the first state when the shift stage is in its first state, all the multiplexing units of the shift stage are in their second state when the shift stage is in its second state, and at least some of the multiplexing units are in their second state when the shift stage is in its third state.

35. The data shift device according to claim 34, wherein the second controller separately controls each multiplexing unit of a shift stage according to the desired shift value.

36. The data shift device according to claim 25, wherein the plurality of inputs comprises N inputs, and the plurality of outputs comprises N outputs; wherein the data that can be received simultaneously as input to the device are organized in a single group of size N or in several groups each having a same intermediate size different than N and greater than 1; the second shifter is arranged and connected according to the at least one predetermined intermediate size and a number g of groups, and the second controller configures the second shifter according to the intermediate size of the group or groups of data that can be received and according to the shift value.

37. The data shift device according to claim 36, wherein the second shifter has a number of shift stages equal to a number of predetermined intermediate sizes, each shift stage being associated with a predetermined intermediate size.

38. The data shift device according to claim 37, wherein the second shifter is connected between some outputs of the barrel shifter and some of the outputs of the device according to the different predetermined organizations of data that can be received simultaneously on at least some of the inputs.

39. The data shift device according to claim 38, wherein each shift stage has a first state in which it is configured to perform a shift of at least one datum per group and a second state in which it is configured to shift no data, and the second controller configures in the first state the shift stage associated with the intermediate size of each group of data that can be received, and configures the other shift stages in the second state, or configures each shift stage in the second state when the data simultaneously received forms a single group of size N.

40. The data shift device according to claim 38, wherein each shift stage has a first state in which it is configured to perform a shift of at least one datum per group, a second state in which it is configured to shift no data and/or a third state in which it is configured to perform no shift of at least some of the data of each group; and wherein the second controller configures in the first state the shift stage associated with the intermediate size of the group of data that can be received, configures in its second or its third state the other shift stages, or configures each shift stage in its second state when the size of the group of data that can be received is equal to one of 1 and N.

41. The data shift device according to claim 40, wherein the shift stage associated with a predetermined intermediate size having a value p comprises g groups of p−1 multiplexing units that can be controlled separately, each multiplexing unit having an output connected to one of the N outputs of the device, a first input connected to an output of the barrel shifter associated with the output of the device and a second input connected to another output of the barrel shifter, each multiplexing unit having a first state in which its output is connected to its second input and a second state in which its output is connected to its first input, and at least one of the multiplexing units is in its first state when the shift stage is in its first state, and each of the multiplexing units of the shift stage are in the second state when the shift stage is in its second state, and at least some of the multiplexing units are in the second state when the shift stage is in its third state.

42. The data shift device according to claim 37, wherein the second shifter is connected between some of the inputs of the device and some inputs of the barrel shifter according to the different predetermined organizations of data that can be received simultaneously on at least some of the inputs of the device.

43. The data shift device according to claim 42, wherein each shift stage has a first state in which it is configured to perform a shift of at least one datum per group, a second state in which it is configured to shift no data and/or a third state in which it is configured to perform no shift of at least some of the data of each group; and wherein the second controller configures in the first state the shift stage associated with the intermediate size of the group of data that can be received, configures in the second state each shift stage disposed between the inputs of the device and the shift stage associated with the intermediate size of the group of data that can be received as input to the device, configures in its second or its third state each shift stage disposed between the shift stage associated with the intermediate size of the group of data that can actually be received as input to the device and the barrel shifter, or configures each shift stage in its second state when the size of the group of data that can be received is equal to one of 1 and N.

44. The data shift device according to claim 43, wherein the shift stage associated with a predetermined intermediate size having a value p comprises g groups of p−1 multiplexing units that can be controlled separately, each multiplexing unit having a first input connected to an input of the device, an output connected to an input of the barrel shifter associated with the input of the device and a second input connected to another input of the device, each multiplexing unit having a first state in which its output is connected to its second input and a second state in which its output is connected to its first input, and at least one of the multiplexing units is in its first state when the shift stage is in its first state, each of the multiplexing units of the shift stage are in their second state when the shift stage is in its second state and at least some of the multiplexing units are in their second state when the shift stage is in its third state.

45. The data shift device according to claim 44, wherein the second controller controls separately each multiplexing unit of a group according to the shift value and controls identically the associated multiplexers of the g groups.

46. The data shift device according to claim 25, wherein the data shift device defines an integrated circuit.

47. A channel coding device to perform an encoding with an LDPC code and comprising a shift device including:
a plurality of inputs;
a plurality of outputs;
a configurable barrel shifter connected between the inputs and the outputs;
a first controller to configure the barrel shifter according to a shift value;
a second shifter arranged and connected to the configurable barrel shifter according to different organizations of data to be respectively received simultaneously on the inputs and configurable so that, for a given organization and regardless of a shift value compatible with the organization, the corresponding input data are delivered to outputs; and
a second controller to configure the second shifter according to the given organization of the data that can be received and according to the shift value.

48. A channel decoding device to perform a decoding of data blocks encoded with an LDPC code and comprising a shift device including:
data shift device comprising:
a plurality of inputs;
a plurality of outputs;
a configurable barrel shifter connected between the inputs and the outputs;
a first controller to configure the barrel shifter according to a shift value;
a second shifter arranged and connected to the configurable barrel shifter according to different organizations of data to be respectively received simultaneously on the inputs and configurable so that, for a given organization and regardless of a shift value compatible with the organization, the corresponding input data are delivered to outputs; and
a second controller to configure the second shifter according to the given organization of the data that can be received and according to the shift value.
